(19) United States
(12) Patent Application Publication
(10) Pub. No.: US 2023/0195543 A1
(43) Pub. Date: Jun. 22, 2023

(54) APPLICATION PROGRAMMING INTERFACE (API) SERVER FOR CORRELATION ENGINE AND POLICY MANAGER (CPE), METHOD AND COMPUTER PROGRAM PRODUCT

(71) Applicant: RAKUTEN MOBILE, INC., Tokyo (JP)

(72) Inventors: Jyoti BOSE, Mumbai (IN); Mihirraj Narendra DIXIT, Tokyo (JP); Surender Singh LAMBA, Tokyo (JP); Abhishek SHARMA, Tokyo (JP)

(21) Appl. No.: 17/644,600

(22) Filed: Dec. 16, 2021

(51) Int. Cl. G06F 9/54; G06F 11/34

(52) U.S. Cl. CPC G06F 9/542; G06F 11/3476

(57) ABSTRACT

An application programming interface (API) server for a correlation engine and policy manager (CPE) system includes a processor, and a memory coupled to the processor. The CPE system includes a plurality of components of various component types, and each component among the plurality of components is configured to perform at least one corresponding processing on event data input to the CPE system. The memory is configured to store executable instructions that, when executed by the processor, cause the processor to perform at least one of registering, removing or updating a configuration of at least one component among the plurality of components of the CPE system, or changing a number of components of a same component type among the various component types, to scale up or down the CPE system.

### BACKGROUND

Event-driven architecture (EDA) is a software architecture paradigm promoting the production, detection, consumption of, and reaction to events. When events occur, event messages are generated and/or propagated. The EDA is often designed atop message-driven architectures, where such a communication pattern includes one of the inputs to be text-based (e.g., the message) to differentiate how each communication should be handled.

In computing, being pluggable (or plugin, add-in, addin, add-on, or addon) references a software component that adds a specific feature to an existing computer program. When a program supports plug-ins, the program enables customization. In computing, on the fly, or at run-time, or in runtime, describes a program or a system being changed while the program or system is still running.

### BRIEF DESCRIPTION OF THE DRAWINGS

Aspects of the present disclosure are best understood from the following detailed description when read with the accompanying FIGS. In accordance with the standard practice in the industry, various features are not drawn to scale. In fact, the dimensions of the various features be arbitrarily increased or reduced for clarity of discussion.

FIG. 1 is a schematic diagram of a correlation engine and policy manager (CPE) system, in accordance with some embodiments.

FIG. 2 is a schematic diagram of a section of a CPE system including an application programming interface (API) server, in accordance with some embodiments.

FIGS. 3A-3B are flow diagrams of various processes of operating an API server in a CPE system, in accordance with some embodiments.

FIG. 4 is a schematic block diagram of a computer system, in accordance with some embodiments.

### DETAILED DESCRIPTION

The following disclosure includes many different embodiments, or examples, for implementing different features of the subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows include embodiments in which the first and second features are formed in direct contact, and also include embodiments in which additional features be formed between the first and second features, such that the first and second features not be in direct contact. In addition, the present disclosure repeats reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, be usable herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus be otherwise oriented (rotated 90 degrees or at other orientations) and the spatially relative descriptors usable herein likewise be interpreted accordingly.

In some embodiments, an event is a notification based message that contains a notification about an entity. In at least one embodiment, an event comprises information or data of the entity.

In some embodiments, event data include data of or about one or more events to be processed, for example, in or by an EDA software and/or system.

In some embodiments, processing performed on event data comprises generation of new data based on the event data, and/or manipulation of the event data. Examples of processing of event data are described herein, in some embodiments with respect to one or more components of a correlation engine and policy manager (CPE) system.

In some embodiments, a configuration of a component comprises a technical and/or technological architecture of the component that permits the component to perform intended processing. For example, a configuration of a component comprises information on one or more modules (e.g., software modules) of the component, how the one or more modules of the component are coupled to each other and/or to other components.

In some embodiments, correlation engine and policy manager (CPE) is a software application that programmatically understands relationships, for example, to aggregate, normalize and analyze event data in accordance with one or more policies set by a user.

In some embodiments, an application programming interface (API) server is provided for a correlation engine and policy manager (CPE) system. The CPE system comprises a plurality of components of various component types, and each component among the plurality of components is configured to perform at least one corresponding processing on event data input to the CPE system. Example component types of the CPE system include, but are not limited to, an event source, an event gate, an event queue, an event enricher, an event transformer, an event sink, an event writer, an event dispatcher or the like. The API server comprises a processor configured to implement one or more of an operational layer, a policy layer, a configuration layer, a monitoring layer, and a cache layer to configure/interact with/control various aspects of the CPE system. For example, the processor of the API server, while implementing the configuration layer, is configured to register, remove or update a configuration of at least one component among the plurality of components of the CPE system. Alternatively or additionally, the processor of the API server, while implementing the configuration layer, is configured to change a number of components of a same component type among the various component types, to scale up or down the CPE system. As a result, it is possible, in one or more embodiments, for a user or vendor to reconfigure, scale up or down, control, monitor or interact with the CPE system in runtime as per the needs of the user or vendor. This is an advantage over other approaches in which the ability to reconfigure, scale up or down, control, or interact with a system in runtime does not exist or is limited.

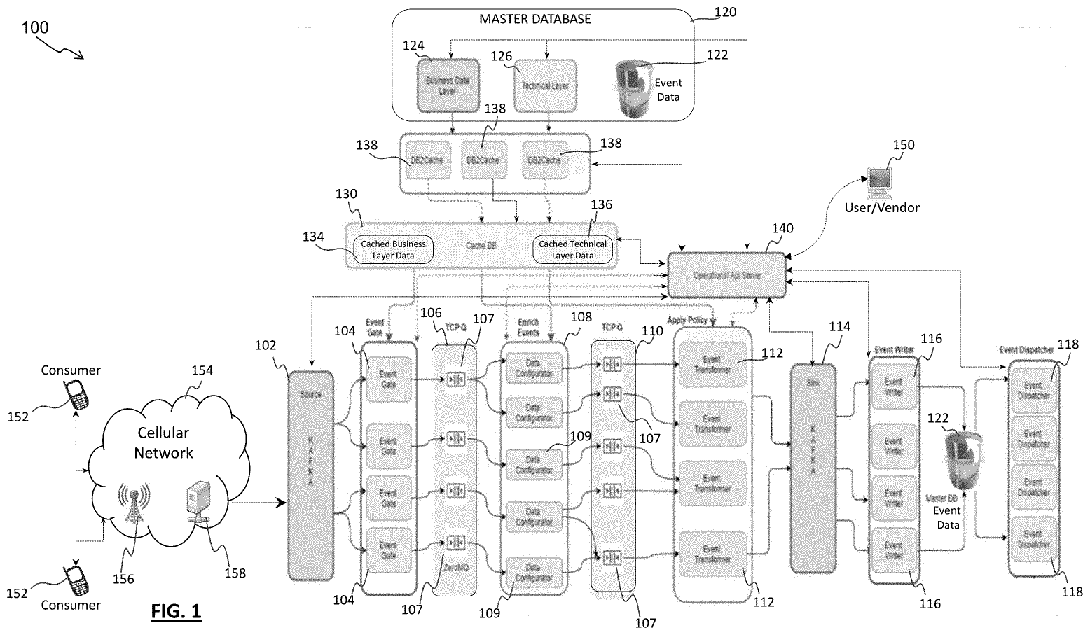

FIG. 1 is a schematic diagram of a correlation engine and policy manager (CPE) system 100, in accordance with some embodiments.

In some embodiments, a correlation engine is a software application that, when executed in computer hardware, programmatically understands relationships. In some embodiments, correlation engines are included in systems management tools to aggregate, normalize and analyze event data, using predictive analytics and fuzzy logic to alert the systems administrator when there is a problem. In some embodiments, the CPE system 100 is a part of an enterprise software platform running on computer hardware. In at least one embodiment, the CPE system 100 comprises a closed-loop system. An example of a closed-loop system comprises an Observability Framework (OBF) in which data obtained from network elements are sent to the CPE system which acts as a feedback system.

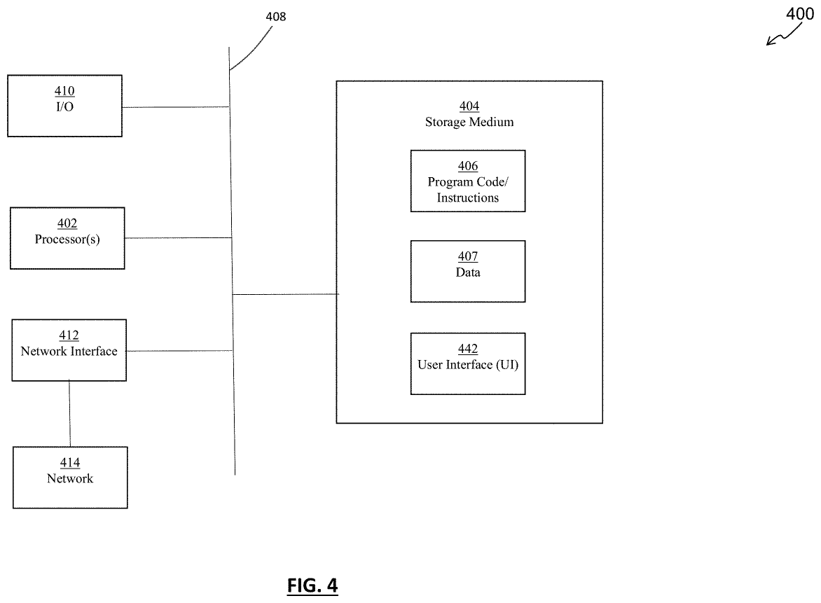

The CPE system 100 comprises a plurality of components including an event source 102, at least one event gate 104, a first event queue 106, at least one event enricher 108, a second event queue 110, at least one event transformer 112, an event sink 114, at least one event writer 116, at least one event dispatcher 118, a master database 120, a cache database 130, and an operational API server 140. In some embodiments, each of the event source 102, at least one event gate 104, first event queue 106, at least one event enricher 108, second event queue 110, at least one event transformer 112, event sink 114, at least one event writer 116, at least one event dispatcher 118, master database 120, cache database 130, and API server 140 is implemented by one or more computer systems and/or coupled with each other via one or more buses and/or networks as described with respect to FIG. 4, and/or via one or more software buses. In some embodiments, functions and/or operations described herein for the components of the CPE system 100 are implemented by one or more hardware processors executing corresponding software or programs. The event source, event gate, event queue, event enricher, event transformer, event sink, event writer, event dispatcher, master database, cache database, are examples of various component types which may be controlled, configured, scaled, monitored, or interacted with from outside the CPE system 100 by using the API server 140, as described herein.

Specifically, the API server 140 is configured to be coupled to user or vendor equipment 150 (hereinafter user/vendor 150) to enable the user/vendor 150 to perform one or more of controlling, configuring, scaling, monitoring, or interacting with the CPE system 100. In at least one embodiment, the user/vendor 150 is a service provider or business that uses the CPE system 100 to provide and/or handle services, e.g., communication services, to/for consumers (also referred to as clients or end users) of the service provider or business. In the example configuration in FIG. 1, consumers use mobile terminals 152 coupled to a cellular network 154 to receive communication services provided by the user/vendor 150. In an example, the cellular network 154 comprises a plurality of cells (not shown) in which cellular services are provided, through corresponding base stations. A representative base station 156 is illustrated in FIG. 1. The base stations constitute a radio access network, and are coupled to a core network of the cellular network 154. A representative network device 158 of the core network is illustrated in FIG. 1. Examples of the cellular network 154 include, but are not limited to, a long term evolution (LTE) network, a fifth generation (5G) network, a non-standalone (NSA) network, a standalone (SA) network, a global system for mobile communications (GSM) network, a general packet radio service (GPRS) network, a code-division multiple access (CDMA) network, a Mobitex network, an enhanced GPRS (EDGE) cellular network, or the like. Example configurations of the base stations include cell towers each having one or more cellular antennas, one or more sets of transmitter/receivers transceivers, digital signal processors, control electronics, a Global Positioning System (GPS) receiver for timing (e.g., for CDMA2000/IS-95 or GSM systems), primary and backup electrical power sources, and sheltering. Examples of mobile terminals 152, include, but are not limited to, cell phones, tablets, media players, gaming consoles, personal data assistants (PDAs), laptops, and other electronic devices configured to transmit and/or receive cellular communication to/from the base stations of the cellular network 154. An example hardware configuration of a mobile terminal and/or a base station includes a computer system described with respect to FIG. 4, with the addition of one or more cellular antennas and corresponding cellular transceiving circuitry. Examples of communication technologies for performing cellular communications between base stations and mobile terminals include, but are not limited to, 2G, 3G, 4G, 5G, GSM, EDGE, WCDMA, HSPA, CDMA, LTE, DECT and WiMAX. Examples of services provided over cellular communication, herein referred to as cellular communication services, include, but are not limited to, voice calls, data, emails, messages such as SMS and MMS, applications, and control signals. Example components (or network devices) of the core network include, but are not limited to, serving gateways (SGW), high rate packet data serving gateway (HSGW), packet data network gateway (PGW), packet data serving node (PDSN), mobility management entity (MME), home subscriber server (HSS), and policy control rules function (PCRF). The components of the core network are coupled with each other and with the base stations by one or more public and/or proprietary networks. An example hardware configuration of a component or network device 158 of the core network includes a computer system described with respect to FIG. 4. In at least one embodiment, the cellular network 154 is coupled to the CPE system 100 via the Internet, a Virtual Private Network (VPN), or the like.

The event source 102 is configured to perform processing such as receiving or collecting event data. In the example configuration in FIG. 1, the event data collected by the event source 102 comprise events or event messages occurring in the cellular network 154 and/or during communication services of mobile terminals 152. Other sources of events are within the scopes of various embodiments, as described herein.

In some embodiments, an event is recognized by software, often originating asynchronously from the external environment that is handled by the software. Computer event messages are generated or triggered by a system, by an end user, or in other ways based upon the event. Event messages are handled synchronously with the program flow; that is, the software is configured to have one or more dedicated places where event messages are handled; frequently an event loop. An example source of event messages includes an end user, who interacts with the software through the computer's peripherals; for example, by typing on the keyboard or initiating a phone call. Another example source is a hardware device such as a timer. Software is configured to also trigger its own set of event messages into the event loop (e.g., to communicate the completion of a task). Software that changes its behavior in response to event messages is said to be event-driven, often with the goal of being interactive.

In some embodiments, the event messages are collected at the event source 102 via one or more a data stream, batch data, online data, and offline data. A stream is thought of as items on a conveyor belt being processed one at a time rather than in large batches. Streams are processed differently from batch data. Functions may not operate on streams as a whole as the streams have potentially unlimited data; streams are co-data (potentially unlimited), not data (which is finite). Functions that operate on a stream, producing another stream, are known as filters, and are connected in pipelines, analogous to function composition. Filters operate on one item of a stream at a time, or base an item of output on multiple items of input, such as a moving average. Computerized batch processing is processing without end user interaction, or processing scheduled to run as resources permit.

In the example configuration in FIG. 1, the event source 102 comprises one or more message buses. In some embodiments, the one or more message buses comprise one or more Kafka sources. Other source or message bus configurations are within the scopes of various embodiments. Kafka is a framework implementation of a software bus using stream-processing. Kafka is an open-source software platform developed by the Apache Software Foundation written in Scala and Java. Kafka provides a unified, high-throughput, low-latency platform for handling real-time data feeds. Kafka can connect to external systems (for data import/export) via Kafka connect and provides Kafka streams, a Java stream processing library. In some embodiments, the event source 102 is configured to use transport protocols, or network communication channel based protocols to receive or read data. In a specific example, a binary TCP-based protocol is used and optimized for efficiency and on a message-set abstraction that naturally groups messages together to reduce the overhead of the network roundtrip. Other protocols are within the scopes of various embodiments. The message-set abstraction leads to larger network packets, larger sequential disk operations, contiguous memory blocks which allows the event source 102 to turn a bursty stream of random message writes into linear writes. In some embodiments, the event source 102 is configured to read or receive data using a predefined format. In a specific example, confluent kafkaavro.AvroProducer is used. Other formats or ways for reading data are within the scopes of various embodiments. In the example configuration in FIG. 1, the CPE system 100 comprises one event source 102. However, other numbers of event sources are within the scopes of various embodiments. For example, in some embodiments, the event source 102 comprises one or more online data sources, offline data sources, streaming data sources, and batch data sources.

The at least one event gate 104 is coupled between the event source 102 and the first event queue 106. As illustrated in FIG. 1, each event gate 104 is coupled between at least one event source 102 and at least one corresponding shared queue 107 of the first event queue 106. The at least one event gate 104 is configured to receive the event data collected by the event source 102. In some embodiments, each event gate 104 is a pluggable data adaptor that connects with multiple types of data sources to collect data, such as event messages, process the event messages into frames, and forward the event data including the event message frame(s) to the at least one event enricher 108. In some embodiments, the event gate 104 is configured to perform processing such as framing collected event messages based on business logic or policies stored in a business layer 124 (also referred to herein as “business data layer”) of the master database 120 and provided to the event gate 104 via the cache database 130.

In some embodiments, business layer data in the business layer 124 comprise business data and business logic. In at least one embodiment, the business data comprise data, rather than logic or rules, such as business data related to consumers, as described herein. The business logic (or domain logic) is a part of a software program that encodes the real-world business rules that determine how data is created, stored, and changed. The business logic contains custom rules or algorithms that handle the exchange of information between a database and a user interface. Business logic is the part of a computer program that contains the information (i.e., in the form of business rules) that defines or constrains how a business operates. Such business rules are operational policies that are usually expressed in true or false binaries. Business logic is seen in the workflows that the business logic supports, such as in sequences or steps that specify in detail the proper flow of information or data, and therefore decision-making.

Business logic is contrasted with a remainder of the software program, such as the technical layer or service layer that is concerned with lower-level details of managing a database or displaying the user interface, system infrastructure, or generally connecting various parts of the program. The technical layer is used to model the technology architecture of an enterprise. The technical layer is the structure and interaction of the platform services, and logical and physical technology components.

In some embodiments, the business layer and the technical layer are separated. In some embodiments, at least one, or some, or all components of the CPE system 100, such as the event source 102, event gate 104, first event queue 106, event enricher 108, second event queue 110, event transformer 112, event sink 114, event writer 116, event dispatcher 118, master database 120, cache database 130, support(s) the separation of the business layer and the technical layer. In some embodiments, the separation of the business layer and the technical layer supports quicker implementation of new business use models or rules which reduces the time to implement new business use solutions and reduces the cost of development by allowing code reuse.

In some embodiments, the behavior of at least one, or some, or all components of the CPE system 100, such as the event source 102, event gate 104, first event queue 106, event enricher 108, second event queue 110, event transformer 112, event sink 114, event writer 116, event dispatcher 118, master database 120, cache database 130, is modifiable on the fly, or in runtime, without changing software code or stopping the one or more components, other components, or the whole CPE system 100. In at least one embodiment, the behavior of a component of the CPE system 100 is modifiable by changing one or more policies applicable to the component, as described herein.

In some embodiments, the configuration or number or connections of at least one, or some, or all components of the CPE system 100, such as the event source 102, event gate 104, first event queue 106, event enricher 108, second event queue 110, event transformer 112, event sink 114, event writer 116, event dispatcher 118, master database 120, cache database 130, are modifiable on the fly, or in runtime, without changing software code or stopping the one or more components, other components, or the whole CPE system 100. In at least one embodiment, the configuration or number or connections of a component of the CPE system 100 is/are modifiable by changing configuration data applicable to the component, as described herein. For example, technical layer data stored in a technical layer 126 (also referred to herein as “technical data layer”) of the master database 120 are accessible through the cache database 130 and comprise configuration data which define one or more of a number of event gates 104 in the CPE system 100, the configuration of each event gate 104, which and/or how many event sources 102 each event gate 104 is coupled to, which and/or how many event enrichers 108 and/or shared queues 107 in the first event queue 106 each event gate 104 is coupled to, or the like.

As described herein, in some embodiments, based on the business logic, the event gate 104 is configured to group the collected event messages into frames, e.g., to perform event batching. Frames are an artificial intelligence data structure used to divide knowledge into substructures by representing stereotyped situations. Frames are the primary data structure used in artificial intelligence frame language; frames are stored as ontologies of sets. In computer science and information science, an ontology encompasses a representation, formal naming and definition of the categories, properties and relations between the concepts, data and entities that substantiate one, many, or all domains of discourse. An ontology is a way of showing the properties of a subject area and how the properties are related, by defining a set of concepts and categories that represent the subject. Frames are also an extensive part of knowledge representation and reasoning schemes. Structural representations assemble facts about a particular object and event message types and arrange the event message types into a large taxonomic hierarchy. In some embodiments, internal metadata are added by the event gate 104 to the event message frames, rather than to the actual event or event message.

In some embodiments, each event gate 104 is configured to supply the collected and framed event messages to at least one event enricher 108 that enriches the framed event messages with additional related or topological data, and then routes the framed event messages based on a user-defined configuration. The event gate 104 is configured to function as a bridge to exchange data between a data source and a disconnected data class, such as a data set. In some embodiments, this means reading data from a database into a dataset, and then writing changed data from the dataset back to the database. At a simple level, the event gate 104 specifies structured query language (SQL) commands that provide elementary create, read, update, and delete (CRUD) functionality. At a more advanced level, the event gate 104 offers the functions required in order to create strongly typed data sets, including data relations.

The first event queue 106 is coupled between the at least one event gate 104 and the at least one event enricher 108. The first event queue 106 is configured to receive the receive the event data including the event message frames output by the at least one event gate 104. In some embodiments, the frames are produced over a messaging queue that uses a transport protocol, or a network communication channel based protocol. In a specific example, a real-time transmission control protocol (TCP) messaging queue (TCP Q) is used as an example of the first event queue 106. Other protocols or messaging queues are within the scopes of various embodiments. Real-time or real time describes operations in computing or other processes that guarantee response times within a specified time (deadline), usually a relatively short time. A real-time process is generally one that happens in defined time steps of maximum duration and fast enough to affect the environment in which the real-time process occurs, such as inputs to a computing system. In computer science, message queues and mailboxes are software-engineering components used for inter-process communication (IPC), or for inter-thread communication within the same process. Message queues use a queue for messaging; the passing of control or of content. In some embodiments, the first event queue 106 is configured to perform processing such as message queueing and/or load balancing between one or more event gates 104 and one or more event enrichers 108.

As illustrated in FIG. 1, the first event queue 106 comprises one or more shared messaging queues 107. Each of the shared queues 107 is coupled between at least one event gate 104 and at least one corresponding event enricher 108. In the specific example configuration in FIG. 1, each shared queue 107 is a ZeroMQ. ZeroMQ is an asynchronous messaging library, aimed at use in distributed or concurrent applications. ZeroMQ provides a message queue, but unlike message-oriented middleware, a ZeroMQ system runs without a dedicated message broker. Other messaging queues are within the scopes of various embodiments. In some embodiments, the technical layer 126 of the master database 120 comprises configuration data which define one or more of a number of shared queues 107 in the first event queue 106, which and/or how many event gates 104 each shared queue 107 is coupled to, which and/or how many event enrichers 108 each shared queue 107 is coupled to, or the like. In some embodiments, the first event queue 106 is entirely or partially omitted. For example, when the first event queue 106, or a part there of, is omitted, at least one event gate 104 is directly coupled to one or more event enrichers 108, in accordance with configuration data of the technical layer 126.

The at least one event enricher 108 is coupled between the first event queue 106 and the second event queue 110. As illustrated in FIG. 1, each event enricher 108 (also referred to as and indicated by “data configurator” in FIG. 1) is coupled between at least one shared queue 107 in the first event queue 106 and at least one corresponding shared queues 107 in the second event queue 110. The at least one event enricher 108 is configured to receive the event data including the event message frames through the first event queue 106. In at least one embodiment, at least one event enricher 108 is configured to receive the event data including event message frames directly from at least one event gate 104. In some embodiments, an event enricher 108 is a daemon service that loads business layer data from the master database 120 and/or the cache database 130. In an Eager mode, the event enricher 108 makes a single query on a database and loads the related entities based upon the query. This is in contrast to Lazy mode that makes multiple database queries to load the related entities. Cache sharing allows each data cache to share the data cache contents with the other caches and avoid duplicate caching.

In some embodiments, the event enricher 108 is configured to perform processing such as applying the loaded business layer data to event message(s) within event message frame(s) received from at least one event gate 104 (either directly, or through the first event queue 106). In some embodiments, the event enricher 108 enriches the event message frame(s) in real time, by supplementing or adding additional business related data from the business layer data. For example, when the event message frame(s) received from at least one event gate 104 includes a telephone number of a consumer, the event enricher 108 enriches the event message frame(s) by adding business data related to the consumer, such as name, address, email, social media account, or the like. In some embodiments, the event enricher compartmentalizes the business layer and the technical layer, where the business layer continues to define new use cases and the technical layer applies those business new use cases in real time on the event message frame(s).

As described herein, the behavior, configuration, number, or connections of the event enricher 108 are modifiable by changing at least one of policies or configuration data applicable to the event enricher 108. For example, one or more policies and/or configuration data applicable to the event enricher 108 define one or more of a number of event enrichers 108 in the CPE system 100, the configuration of each event enricher 108, which and/or how many event gates 104 or shared queues 107 in the first event queue 106 each event enricher 108 is coupled to, which and/or how many event transformers 112 or shared queues 107 in the second event queue 110 each event enricher 108 is coupled to, or the like.

The second event queue 110 is coupled between the at least one event enricher 108 and the at least one event transformer 112. The second event queue 110 is configured to receive the event data including the enriched event message frames output by the at least one event enricher 108. In some embodiments, the second event queue 110 is configured similarly to the first event queue 106, and comprises one or more shared queues 107. As illustrated in FIG. 1, each of the shared queues 107 in the second event queue 110 is coupled between at least one event enricher 108 and at least one corresponding event transformer 112. In some embodiments, the second event queue 110 is configured to perform load balancing between one or more event enrichers 108 and one or more event transformers 112. In some embodiments, the technical layer 126 of the master database 120 comprises configuration data which define one or more of a number of shared queues 107 in the second event queue 110, which and/or how many event enrichers 108 each shared queue 107 in the second event queue 110 is coupled to, which and/or how many event sinks 114 each shared queue 107 in the second event queue 110 is coupled to, or the like. In some embodiments, the second event queue 110 is entirely or partially omitted. For example, when the second event queue 110, or a part there of, is omitted, at least one event enricher 108 is directly coupled to one or more event sinks 114, in accordance with configuration data of the technical layer 126.

In some embodiments, one or more or all of the first event queue 106, event enricher 108, second event queue 110 is/are omitted.

The at least one event transformer 112 is coupled between the second event queue 110 and the event sink 114. In at least one embodiment, the event sink 114 comprises multiple event sinks. As illustrated in FIG. 1, each event transformer 112 is coupled between at least one shared queue 107 in the second event queue 110 and at least one corresponding event sink 114. The at least one event transformer 112 is configured to receive the event data including the enriched event message frames through the second event queue 110. In at least one embodiment, at least one event transformer 112 is configured to receive the event data including enriched event message frames directly from at least one event enricher 108. In some embodiments, the at least one event transformer 112 is configured to perform processing such as listening to events on the second event queue 110, applying at least one policy (e.g., rules) on the event data and the corresponding enriched event message frame, transforming the enriched event message frame applied with the at least one policy, and outputting the event data and the corresponding transformed enriched event message frame to a corresponding partition in the event sink 114 based on the rules applied to the event data. In at least one embodiment, the event transformer 112 is further configured to generate a notification on the corresponding partition. In a specific example, a partition comprises a Kafka topic. Other types of partition are within the scopes of various embodiments. As described herein, the behavior, configuration, number, or connections of the event transformer 112 are modifiable by changing at least one of policies or configuration data applicable to the event transformer 112. For example, one or more policies and/or configuration data applicable to the event transformer 112 define one or more of a number of event transformers 112 in the CPE system 100, the configuration of each event transformer 112, which and/or how many event enrichers 108 or shared queues 107 in the second event queue 110 each event transformer 112 is coupled to, which and/or how many event sinks 114 each event transformer 112 is coupled to, or the like.

The event sink 114 is coupled between the at least one event transformer 112 and the at least one event writer 116. The event sink 114 is configured to perform processing such as receiving and/or collecting the event data including the transformed enriched event message frames output by the at least one event transformer 112. In some embodiments, the event sink 114 is configured similarly to the event source 102, and/or comprises one or more partitions or sinks. In some embodiments, the event data including the corresponding transformed enriched event message frame(s) are sent to a particular event sink based on a routing policy. As described herein, the behavior, configuration, number, or connections of one or more event sources 102 and/or one or more event sinks 114 are modifiable by changing at least one of policies or configuration data applicable correspondingly to the event sources 102 and/or event sinks 114.

The at least one event writer 116 is coupled between the event sink 114 and an event data section 122 of the master database 120. In at least one embodiment, each event writer 116 is coupled to at least one corresponding event sink 114 or topic, to receive the event data including the corresponding transformed enriched event message frames. Each event writer 116 is configured to perform processing such as reading the event data including transformed enriched event message frames from the corresponding topic or event sink 114, and inserting the event data into a corresponding region in the event data section 122. As a result, event data in the same region of the event data section 122 are accumulated or bulked. As described herein, the behavior, configuration, number, or connections of the event writer 116 are modifiable by changing at least one of policies or configuration data applicable to the event writer 116. For example, one or more policies and/or configuration data applicable to the event writer 116 define one or more of a number of event writers 116 in the CPE system 100, the configuration of each event writer 116, which event sink 114 and/or which region in the event data section 122 each event writer 116 is coupled to, or the like.

The at least one event dispatcher 118 is coupled to the event data section 122 of the master database 120. In at least one embodiment, each event dispatcher 118 is coupled to a corresponding region in the event data section 122 to read, e.g., at a predetermined interval or per a user request, the event data including the corresponding transformed enriched event message frames. When the event data and/or corresponding transformed enriched event message frames meet a criterion or a condition is triggered, the event dispatcher 118 is configured to perform processing such as invoking a corresponding API function, outputting the event data with or without corresponding metadata and/or business data, or generating a notification or alarm prompting actions to be taken. In an example, an output from the event dispatcher 118 indicates an anomaly or quality degradation in the communication services experienced by a consumer, prompting a corrective action to be taken automatically, or manually by a domain expert, to rectify the issues. An example corrective action includes load rebalancing to remove the anomaly and/or restore the intended quality of communication services experienced by the consumer. As described herein, the behavior, configuration, number, or connections of the event dispatcher 118 are modifiable by changing at least one of policies or configuration data applicable to the event dispatcher 118. For example, one or more policies and/or configuration data applicable to the event dispatcher 118 define one or more of a number of event dispatchers 118 in the CPE system 100, the configuration of each event dispatcher 118, which region of the event data section 122 and/or when the region is to be accessed by each event dispatcher 118, or the like.

In at least one embodiment, one or more of components of the CPE system 100, such as the event source 102, event gate 104, first event queue 106, event enricher 108, second event queue 110, event transformer 112, event sink 114, event writer 116, event dispatcher 118 reuse at least partially the same programming codes. In at least one embodiment, one or more components of the CPE system 100 is/are pluggable in nature. In at least one embodiment, one or more components of the CPE system 100 is/are scalable and configured to be scaled in every use and/or in runtime. In some embodiments, it is possible to change a flow of the event data through various components of the CPE system 100. For example, an initial flow of event data is from an event gate 104, through an event enricher 108, to an event transformer 112. By changing a configuration or configurations of one or more of event gate 104, event enricher 108, event transformer 112, the flow of event data is changed to a direct flow from the initial event gate 104 (or a different event gate 104) to the initial event transformer 112 (or a different event transformer 112), without passing through any event enricher 108. Other arrangements for changing event data flows are within the scopes of various embodiments.

As described herein, the master database 120 (also referred to herein as “persistent database”) comprises the event data section 122, the business layer 124, and the technical layer 126. For drawing simplicity, the event data section 122 has two corresponding illustrations in FIG. 1; however, both illustrations indicate the same event data section 122. The event data section 122 stores the event data received through the event source 102, together with metadata and/or transformed enriched event message frames added and/or grouped by one or more of the event gate 104, event enricher 108, second event queue 110.

The business layer 124 contains business layer data defined or input by the user/vendor 150 through the API server 140. The business layer data, as described herein, comprises various policies applicable to one or more components of the CPE system 100 and/or business data to be added to the event data received through the event source 102. In some embodiments, the policies or business logic define how event data are processed, grouped, enriched, transformed, stored in and/or output from the event data section 122. In some embodiments, the master database 120 comprises multiple business layers 124 each corresponding, for example, to a different user/vendor.

Example rules defined in the business logic or policies include, but are not limited to, unordered-threshold-based rules, unordered-time-based rules, ordered rules, schedule-based rules, or the like. An example unordered-threshold-based rule includes a policy condition that NodeDown>=1 and NodeNotReady>=0 with a hold time of 10 min. In this rule, it is not necessary to wait for the entire hold time, i.e., once the thresholds are exceeded, a trigger is generated. An example unordered-time-based rule includes a policy condition that F1SctpFailure>1 and F1SctpSuccess<1 with a hold time of 10 min. In this rule, the system waits for the for the entire hold time and if the condition is still satisfied, a trigger is generated. An example ordered rule includes a policy condition that Event_Pod_Failure followed by Event_Pod_Restarted. In this rule, when the order of events matches the condition, a trigger is generated. An example schedule-based rule includes a policy condition that Every Tuesday at 10 pm, take X action. In this rule, actions are taken based on a schedule rather than on events. In some embodiments, the described rules are applied by at least one event transformer 112.

While the business layer 124 defines behavior of the CPE system 100, the technical layer 126 contains technical layer data (also referred to herein as “technical data” or “configuration data”) which define size and/or shape of the CPE system 100, in accordance with inputs from the user/vendor 150. For example, as described herein, the configuration data in the technical layer 126 define the number of each component type (e.g., the number of event gates 104), the configuration of each component, and/or how the components of the CPE system 100 are coupled to each other as described herein. In some embodiments, the master database 120 comprises multiple technical layers 126 each corresponding, for example, to a different user/vendor. In some embodiments, the entire configuration and/or behavior of the CPE system 100 are determined and/or customizable by the user/vendor 150 who inputs the desired business layer data and configuration data into the master database 120 through the API server 140.

The cache database 130 contains cached versions of the business layer data and technical layer data stored in the master database 120. In computing, a cache is a hardware or software component that stores data so that future requests for that data can be served faster. The data stored in a cache is the result of an earlier computation or a copy of data stored elsewhere. Cache hits are served by reading data from the cache, which is faster than re-computing a result or reading from a slower data store; thus, the more requests that are served from the cache, the faster the system performs. Example caches include, but are not limited to, an internal cache, a query cache, or the like. An internal cache keep results ready that the internal cache thinks the user might need based on usage patterns. A query cache stores results when a query is made more than once (e.g., for a configuration file for a component of the CPE system 100) and the result is cached and returned from a memory, e.g., a random access memory (RAM). When the RAM runs out, the least recently used query is deleted to make space for new ones. When the underlying data changes, either on a table or row/document level, depending on the database, the cache is cleared.

In the example configuration in FIG. 1, the cache database 130 comprises cached business layer data 134 (also referred to as “cached business layer data”) and cached technical layer data 136 (also referred to as “cached technical layer data”). The cached business layer data 134 is a cached version of at least a portion, or the entirety, of the business layer data in the business layer 124. The cached technical layer data 136 is a cached version of at least a portion, or the entirety, of the technical layer data in the technical layer 126. The cache database 130 is coupled to other components in the CPE system 100 to provide the corresponding business data, policies and configuration data to the other components to control the behaviors and/or configurations of the other components. In the example configuration in FIG. 1, for simplicity, the cache database 130 is illustrated as being coupled to the event gate 104, event enricher 108, event transformer 112. However, in one or more embodiments, the cache database 130 is also coupled to one of the other components, such as one or more of the event source 102, first event queue 106, second event queue 110, event sink 114, event writer 116, event dispatcher 118. In at least one embodiment, the cache database 130 improves processing speed, as described herein.

The cached business layer data 134 and/or cached technical layer data 136 are synched with the business layer data and technical layer data of the master database 120 by one or more DB2Cache (database-to-cache) modules 138. In some embodiments, the DB2Cache modules 138 are part of the cache database 130. In at least one embodiment, the DB2Cache modules 138 are independent from the cache database 130. The DB2Cache modules 138 are implemented by one or more hardware processors executing corresponding software or programs. In at least one embodiment, the number of DB2Cache modules 138 corresponds to a caching speed at which the business layer data and technical layer data are cached from the master database 120 into the cache database 130. For example, the higher the number of DB2Cache modules 138, the higher the caching speed. In some embodiments, the number of DB2Cache modules 138 is configurable by user input received through the API server 140. In at least one embodiment, the number of DB2Cache modules 138 is automatically controllable, e.g., depending on the amount of data to be cached. Example modes of operation of the DB2Cache modules 138 include, but are not limited to, an incremental mode, a by-request mode, a full mode, or the like. In the incremental mode, the DB2Cache modules 138 are configured to monitor the master database 120 for new data and, when new data are detected, load the new data into the cache database 130. In the by-request mode, the DB2Cache modules 138 are configured to patch the cache database 130 and/or the master database 120 in response to user input, for example, received through the API server 140. In the full mode, the DB2Cache modules 138 are configured to clean the entire cache database 130, and load all business layer data and technical layer data again from the master database 120. Other configurations of the DB2Cache modules 138 and/or cache database 130 are within the scopes of various embodiments.

The API server 140 is coupled between the user/vendor 150 on one hand, and the other components of the CPE system 100 on the other hand. An API is a connection between computers or between computer programs. API is a type of software interface, offering a service to other pieces of software. The API server 140 is configured to receive one or more of controls, business layer data, technical layer data from the user/vendor 150. The API server 140 is coupled to the other components of the CPE system 100. In some embodiments, the API server 140 is configured to control, in runtime, the other components of the CPE system 100 in accordance with controls received from the user/vendor 150. In some embodiments, the API server 140 is configured to provide the user-defined business layer data and technical layer data from the user/vendor 150 to the corresponding business layer 124 and technical layer 126 in the master database 120. The user-defined business layer data and technical layer data are cached in the corresponding cached business layer data 13, cached technical layer data 136 of the cache database 130. The other components of the CPE system 100, such as one or more of the event source 102, event gate 104, first event queue 106, event enricher 108, second event queue 110, event transformer 112, event writer 116, event dispatcher 118 are configured to obtain the corresponding policies, business data and configuration data from the cache database 130, and apply the corresponding policies, business data and configuration data to process the event data and/or to configure the components, as described herein.

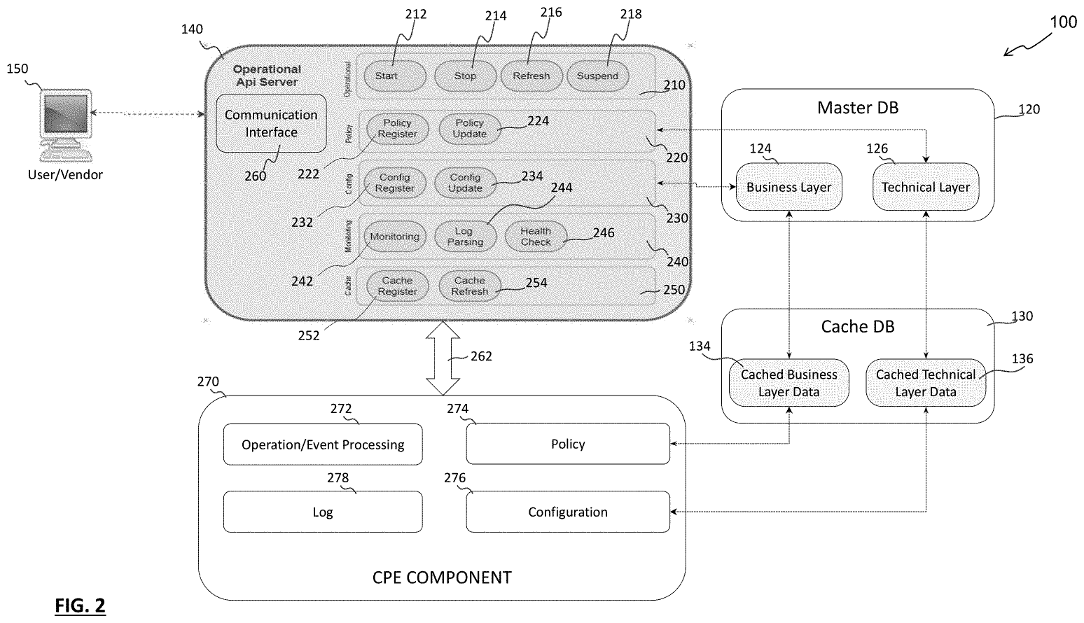

In some embodiments, the API server 140 is a centralized API server configured to control or configure the CPE system 100 system in runtime in response to inputs from the user/vendor 150, as per the needs of the user/vendor 150. In at least one embodiment, the entire configuration and/or operation of the CPE system 100 is/are controllable and/or customizable by the user/vendor 150 through the API server 140. This advantage is not observable in other approaches. In at least one embodiment, it is possible for more than one user/vendors 150 to use and share control/configuration of the CPE system 100, e.g., by receiving through the API server 140 several sets of business layer data and technical layer data each from one of the user/vendors 150, and by configuring/controlling the CPE system 100 correspondingly based on the user-defined sets of business layer data and technical layer data. A detailed description of operations and/or configuration of the API server 140 is given with respect to FIG. 2.

In some embodiments, the API server 140 is applicable in a correlation engine and policy manager (CPE), such as the CPE system 100. CPE is a software application that programmatically understands relationships. CPE is used in systems management tools to aggregate, normalize and analyze event log data, using predictive analytics and fuzzy logic to alert the systems administrator when there is a problem. In some embodiments, CPE is a part of an event-driven architecture (EDA) or service-oriented architecture (SOA) platform.

An EDA architectural pattern is applied by the design and implementation of applications and systems that transmit event messages among loosely coupled software components and services. An event-driven system includes event emitters (or agents, data sources), event consumers (or sinks), and event channels (or the medium the event messages travel from emitter to consumer). Event emitters detect, gather, and transfer event messages. An event emitter may not know the consumers of the event messages, the event emitter may not even know if an event consumer exists, and in case the event consumer exists, the event emitter may not know how the event message is used or further processed. Event consumers apply a reaction as soon as an event message is presented. The reaction is or is not completely provided by the event consumer. For example, the event consumer filters the event message frame(s) while the event formatter and router transforms and forwards the event message frame(s) to another component or the event consumer supplies a self-contained reaction to such event message frame(s). Event channels are conduits in which event message frame(s) are transmitted from event emitters to event consumers. In some embodiments, event consumers become event emitters after receiving event message frame(s) and then forwarding the event message frame(s) to other event consumers. The configuration of the correct distribution of event message frame(s) is present within the event channel. The physical implementation of event channels is based on components, such as message-oriented middleware or point-to-point communication, which might rely on a more appropriate transactional executive framework (such as a configuration file that establishes the event channel).

Enterprise software, further known as enterprise application software (EAS), is one example of EDA software. EAS is computer software used to satisfy needs of an organization rather than individual consumers. Such organizations include businesses, schools, interest-based user groups, clubs, charities, and governments. Enterprise software is a part of a (computer-based) information system; a collection of such software is called an enterprise system. These systems handle a chunk of operations in an organization with the aim of enhancing the business and management reporting tasks. The systems process the information at a relatively high speed and deploy the information across a variety of networks. Services provided by enterprise software are business-oriented tools, such as online shopping, and online payment processing, interactive product catalogue, automated billing systems, security, business process management, enterprise content management, information technology (IT) service management, customer relationship management, enterprise resource planning, business intelligence, project management, collaboration, human resource management, manufacturing, occupational health and safety, enterprise application integration, and enterprise forms automation.

Event-driven service-oriented architecture (SOA) combines the intelligence and proactiveness of EDA with the organizational capabilities found in service offerings. An SOA platform orchestrates services centrally, through pre-defined business processes, assuming that what should have already been triggered is defined in a business process.

Other approach does not account for event message frame(s) that occur across, or outside of, specific business processes. Thus, complex event message frame(s), in which a pattern of activities, both non-scheduled and scheduled, are not accounted for in other approaches, in contrast to one or more embodiments. Other EDA or SOA approaches are not configured to support a single solution for several or multiple types of data, data collectors, or data sources, in contrast to one or more embodiments. Further, other EDA or SOA approaches do not support collecting data in both data streams and in batch data, in contrast to one or more embodiments. Other EDA or SOA approaches do not have a business layer to group data based on business logic, in contrast to one or more embodiments.

FIG. 2 is a schematic diagram of a section of the CPE system 100 including the API server 140, in accordance with some embodiments. Corresponding elements in FIGS. 1 and 2 are designated by the same reference numerals.

The section of the CPE system 100 illustrated in FIG. 2 comprises the master database 120, the cache database 130 and a CPE component 270. For simplicity, the DB2Cache modules 138 between the master database 120 and cache database 130, and the event data section 122 in the master database 120 are omitted in FIG. 2. In at least one embodiment, the CPE component 270 corresponds to at least one of the event source 102, event gate 104, first event queue 106, event enricher 108, second event queue 110, event transformer 112, event sink 114, event writer 116, event dispatcher 118, DB2Cache module 138.

The API server 140 comprises a plurality of API layers each comprising a set of APIs corresponding to a plurality of functions that enable the user/vendor 150 to control, configure or interact with the CPE system 100 in runtime. In the example configuration in FIG. 2, the plurality of API layers of the API server 140 comprises an operational layer 210, a policy layer 220, a configuration layer 230, a monitoring layer 240, and a cache layer 250. In at least one embodiment, one or more of the described API layers 210-250 is/are omitted. The described API layers 210-250 are examples, and other API layers are within the scopes of various embodiments. The API layers 210-250 comprise corresponding sets of APIs described herein. In at least one embodiment, each API in each of the API layers 210-250 is implemented by one or more hardware processors executing corresponding software or programs.

The API server 140 further comprises communication interface 260 configured to communicate with the user/vendor 150. Examples of the communication interface 260 include, but are not limited to, a hardware bus, cellular communication circuitry, a network interface, a software bus, or the like. The API server 140 is coupled to the other components of the CPE system 100 by one or more connections. A representative connection 262 is illustrated in FIG. 2, between the API server 140 and the CPE component 270. Additional, similar connections (not shown) are provided among the API server 140, the master database 120, the cache database 130, the CPE component 270. In at least one embodiment, the connections among components of the CPE system 100 are implemented by one or more hardware buses, cellular communication circuitry, network interfaces, software buses, or the like.

The CPE component 270 comprises operation/event processing module 272, at least one policy 274, configuration data 276, and a log 278. In at least one embodiment, the at least one policy 274, configuration data 276, and log 278 are stored in a non-transitory computer-readable medium as described herein. In at least one embodiment, the operation/event processing module 272 is implemented by one or more hardware processors executing corresponding software or programs.

In some embodiments, user-defined policies are input by the user/vendor 150 into the API server 140 via the communication circuitry 260. The user-defined policies are processed and forwarded by the policy layer 220 to the master database 120 to be stored at the business layer 124. The cache database 130 is synchronized, e.g., by one or more DB2Cache modules, with the master database 120, obtains and stores a cached version of the user-defined policies as cached business layer data 134. In some embodiments, the cached business layer data 134 comprise policies for multiple CPE components of the CPE system 100. Each of the CPE components is configured to access the cached business layer data 134 to retrieve the corresponding policy applicable to that CPE component. For example, the CPE component 270 is configured to access the cached business layer data 134 to retrieve the corresponding at least one policy 274. Alternatively, the cache database 130 is configured to push corresponding policies to at least one of the CPE components of the CPE system 100.

Similarly, user-define technical layer data are input by the user/vendor 150 into the API server 140 via the communication circuitry 260. The user-defined technical layer data are processed and forwarded by the configuration layer 230 to the master database 120 to be stored at the technical layer 126. The cache database 130 is synchronized, e.g., by one or more DB2Cache modules, with the master database 120, obtains and stores a cached version of the user-defined technical layer data as cached technical layer data 136. In some embodiments, the cached technical layer data 136 comprise configuration data for multiple CPE components of the CPE system 100. Each of the CPE components is configured to access the cached technical layer data 136 to retrieve the corresponding configuration data applicable to that CPE component. For example, the CPE component 270 is configured to access the cached technical layer data 136 to retrieve the corresponding configuration data 276. Alternatively, the cache database 130 is configured to push corresponding configuration data to at least one of the CPE components of the CPE system 100.

The operation/event processing module 272 is configured to perform a corresponding processing on the event data input to the CPE component 270 by executing functions of the CPE component 270, using the at least one policy 274 and the configuration data 276. Log data about operations or functions of the operation/event processing module 272 are generated by the operation/event processing module 272 and stored in the log 278.

In some embodiments, the configuration data 276 define technical aspects including, but not limited to, one or more data sources, one or more data sinks, one or more parameters for one or more operations to be performed by the operation/event processing module 272, a number of instances of the operation/event processing module 272 to be executed at the same time, or the like. In an example, when the CPE component 270 corresponds to an event gate 104, the configuration data 276 indicate one or more event sources 102 as data sources, one or more shared queues 107 in the first event queue 106 as data sinks, and one or more parameters based on which the operation/event processing module 272 is configured to group event messages into frames, as described herein. A number of the event gates 104 to be instantiated or executed is also determined by the configuration data 276, for example, based on the number of data sources and/or data sinks. In another example, when the CPE component 270 corresponds to an event enricher 108, the configuration data 276 indicate one or more shared queues 107 in the first event queue 106 as data sources, one or more shared queues 107 in the second event queue 110 as data sinks, and one or more parameters based on which the operation/event processing module 272 is configured to enrich the event message frames, as described herein. A number of the event enrichers 108 to be instantiated or executed is also determined by the configuration data 276, for example, based on the number of data sources and/or data sinks. In yet another example, when the CPE component 270 corresponds to an event transformer 112, the configuration data 276 indicate one or more shared queues 107 in the second event queue 110 as data sources, one or more event sinks as data sinks, and one or more parameters based on which the operation/event processing module 272 is configured to transform the enriched event message frames, as described herein. A number of the event transformers 112 to be instantiated or executed is also determined by the configuration data 276, for example, based on the number of data sources and/or data sinks.

In some embodiments, the at least one policy 274 defines one or more rules and/or business data to be applied to the event data and/or event message frames by the operation/event processing module 272. In an example, when the CPE component 270 corresponds to an event gate 104, the at least one policy 274 defines one or more rules indicating which event messages are to be grouped by the operation/event processing module 272, and into which event message frames. In another example, when the CPE component 270 corresponds to an event enricher 108, the at least one policy 274 defines which business data (e.g., of a consumers) to be added to an event message frame. In at least one embodiment, the business data to be added to the event message frame are retrieved by the operation/event processing module 272 from the business layer 124 via the cached business layer data 134. In yet another example, when the CPE component 270 corresponds to an event transformer 112, the at least one policy 274 defines one or more rules which, when satisfied by the event data and/or the enriched event message frame, cause a trigger or notification to be generated, as described herein.

In some embodiments, the at least one policy 274 and/or configuration data 276 are inputted, modified, and controlled by the user/vendor 150 through the API server 140 in real time and/or in runtime. As a result, in at least one embodiment, it is possible to for a user or vendor to reconfigure, scale up or down, control, monitor or interact with the CPE system 100 in runtime, in response to the user or vendor's input. In some embodiments, inputs from the user/vendor 150 are automatically generated by user/vendor equipment, e.g., a network device or a computer system. In one or more embodiments, inputs from the user/vendor 150 are manually provided by, or provided in response to an action of, a human operator.

The operational layer 210 of the API server 140 comprises a plurality of operational APIs including Start API 212, Stop API 214, Refresh API 216, Suspend API 218. The described APIs of the operational layer 210 are examples, and other APIs for the operational layer 210 are within the scopes of various embodiments. In some embodiments, the APIs of the operational layer 210 are configured to enable the user/vendor 150 to control each or any component of the CPE system 100 individually. In some embodiments, each of the event gate 104, event enricher 108, event transformer 112, event writer 116, event dispatcher 118, business layer 124, technical layer 126, DB2Cache module 138, cache database 130, or the like, is operable individually and/or independently from other components of the CPE system 100 by operating a corresponding API of the operational layer 210. For example, the Start API 212 is configured to enable the user/vendor 150 to execute a start operation to instantiate an event gate 104, while the Stop API 214 is configured to enable the user/vendor 150 to execute a stop operation to close and/or terminate the event gate 104. For another example, in some situations where an event enricher 108 is not needed to enrich the event data or frames, the event enricher 108 is simply turned off, e.g., via the Stop API 214. For a further example, the Refresh API 216 is configured to enable the user/vendor 150 to restart the process of a desired component, such as an event enricher 108. For yet another example, the Suspend API 218 is configured to enable the user/vendor 150 to temporarily suspend, or pause, the process of a desired component, such as an event gate 104. In contrast to the Stop API 214 which completely kills or terminates the process of the desired component, the Suspend API 218 pauses but does not kill or terminate the process of the desired component. For a further example, during ticket/change management, there are situations where the CPE system 100 is not needed, and therefore, instead of controlling via a robin environment, it is possible to control at the process level. The operational layer 210 exposes the corresponding APIs to create events on various components of the CPE system 100 such as the event gate 104, event enricher 108, event transformer 112. These events hold signature of the corresponding Start, Stop, Refresh and/or Suspend APIs. In one or more embodiments, the operational layer 210 makes it possible to perform various operations with respect to different components to create a dynamic architecture of the CPE system 100.

The policy layer 220 of the API server 140 comprises a plurality of policy APIs including Policy Register API 222, Policy Update API 224. The described APIs of the policy layer 220 are examples, and other APIs for the policy layer 220 are within the scopes of various embodiments. In some embodiments, the APIs of the policy layer 220 are configured to enable the user/vendor 150 to register, remove, update various policies and/or business data, with support for all CRUD operations. For example, the Policy Register API 222 is configured to enable the user/vendor 150 to register a new policy, while the Policy Update API 224 is configured to enable the user/vendor 150 to update or remove an existing policy. In at least one embodiment, policies include entities, define which action needs to be taken, define various conditions which need to be fulfilled and what type of data is needed to validate these condition against. In some embodiments, refresh events or externally created events for multi layered correlation are added to the CPE system 100 via the policy layer 220. The policy layer 220 exposes the corresponding APIs to perform registering, removing or updating a policy to be applied by at least one component of the CPE system 100 to the event data when the at least one component performs corresponding processing on the event data. In some embodiments, the policy being registered, removed or updated comprises at least one of one or more actions to be taken by the corresponding component with respect to the event data, one or more conditions to be fulfilled before the one or more actions are taken by the corresponding component, or one or more types of event data against which the one or more conditions are to be validated. In some embodiments, any policy of any one or more components that needs to be inputted or updated during the runtime is simply added to the CPE system 100 via the API server 140 in response to user input from user/vendor 150.

The configuration layer 230 of the API server 140 comprises a plurality of configuration APIs including Configuration Register API 232, Configuration Update API 234. The described APIs of the configuration layer 230 are examples, and other APIs for the configuration layer 230 are within the scopes of various embodiments. In some embodiments, the APIs of the configuration layer 230 are configured to enable the user/vendor 150 to register, remove, update various configuration data, with support for all CRUD operations. For example, the Configuration Register API 232 is configured to enable the user/vendor 150 to register a new configuration of a component in the CPE system 100, while the Configuration Update API 234 is configured to enable the user/vendor 150 to update or remove an existing configuration. In some embodiments, the configuration layer 230 is configured to enable registering, removing or updating a configuration of at least one component among the plurality of components of the CPE system 100, and/or to enable changing a number of components (e.g., the number of event gates 104) of a same component type (e.g., event gate) among various component types, to scale up or down the CPE system 100. In at least one embodiment, when a configuration of a component of the CPE system 100 is created, updated or deleted, the configuration layer 230 is configured to multicast that information to one or more components that are coupled to or related to the component having the created, updated or deleted configuration. For example, the multicast information comprises the registered, removed or updated configuration of the component (e.g., event gate 104), and/or the changed number of components (e.g., number of event gates 104) of the same component type.

The configuration layer 230 exposes APIs to create, update or delete configurations of one or more components of the CPE system 100. In an example, by creating, updating or removing a configuration of a component, e.g., event gate 104, it is possible to scale the event gate 104 up from one instance to multiple instances, or scale the event gate 104 down to a fewer number of instances, or to change the data source (e.g., event sources 102) or data sink (e.g., shared queues 107 in the first event queue 106). In a further example, a configuration for an event enricher 108 is configured to enable the event enricher 108 to communicate with, and retrieve business data for enrichment from, multiple business data layers. In another example, any particular technical configuration of any one or more components that needs to be inputted or updated during the runtime is simply added to the CPE system 100 via the API server 140 in response to user input from user/vendor 150. In yet another example, creating, updating or removing one or more configurations of one or more components of the CPE system 100 make it possible to change a flow of event data through the CPE system 100, as described herein.

The monitoring layer 240 of the API server 140 comprises a plurality of monitoring APIs including Monitoring API 242, Log Parsing API 244, Health Check API 246. The described APIs of the monitoring layer 240 are examples, and other APIs for the monitoring layer 240 are within the scopes of various embodiments. In some embodiments, the APIs of the monitoring layer 240 are configured to enable the user/vendor 150 to perform at least one of monitoring, log parsing, or health check for at least one or any component of the CPE system 100. For example, the Monitoring API 242 is configured to enable the user/vendor 150 to input and monitor a particular logic for correlating between logs, such as “Event-Policy Based Correlation.” Various metrics monitorable by the Monitoring API 242 include, but are not limited to, how many times a particular policy has enacted, how many times was the policy successful or failed, or the like. For a further example, the Log Parsing API 244 is configured to enable the user/vendor 150 to search for particular information, such as, whether the events from a data source to a data sink were reconciled correctly or not, whether the events got enriched correctly or not, or whether the CPE system 100 behaved correctly during a condition evaluation or not. For another example, the Health Check API 246 is configured to enable the user/vendor 150 to interactively obtain the runtime status of each process of every individual module (or component) in the CPE system 100. The monitoring layer 240 exposes APIs that help the user/vendor 150 to monitor the CPE system 100, to search for log information, and to check the process status or health.

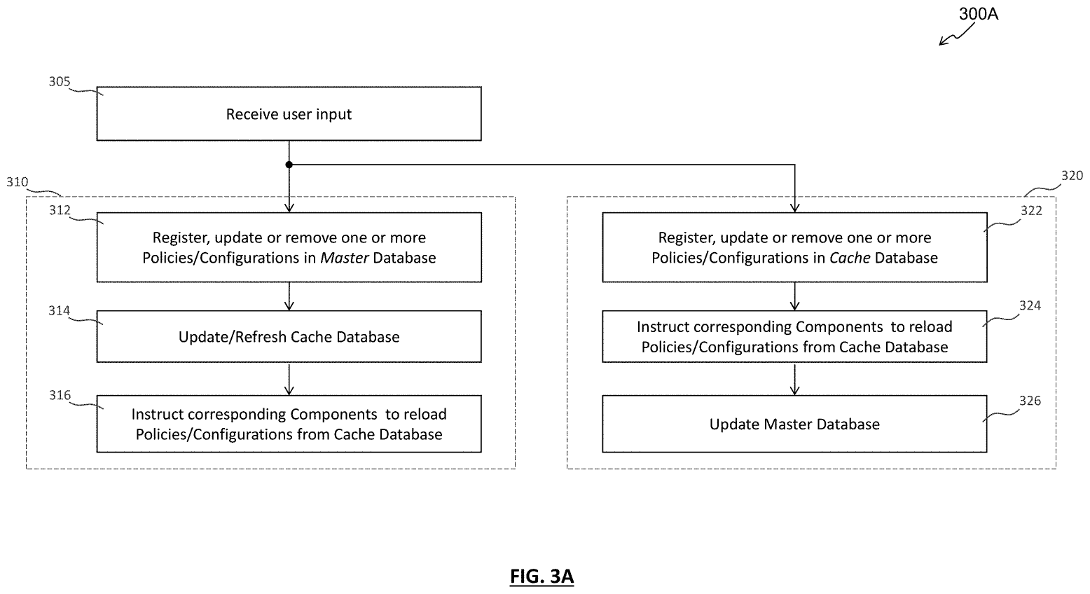

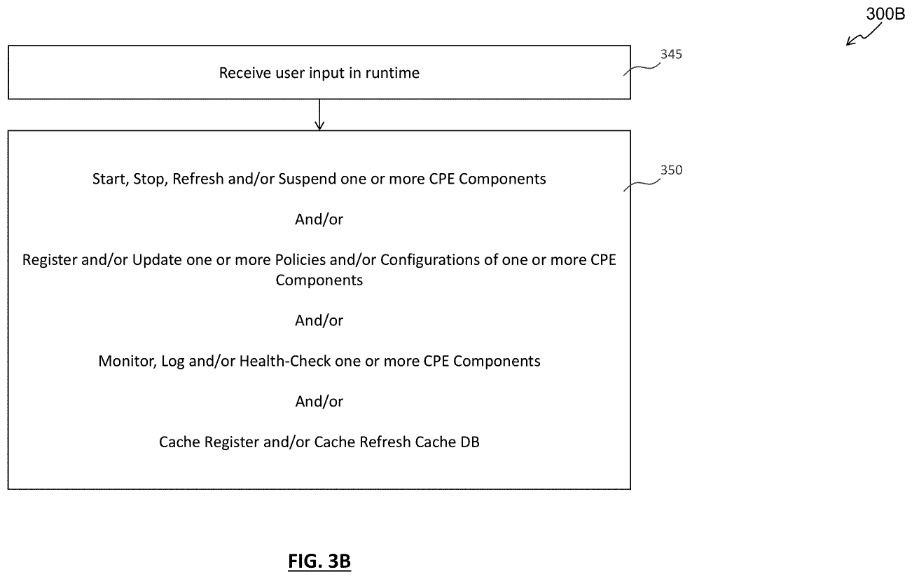

The cache layer 250 of the API server 140 comprises a plurality of cache APIs including Cache Register API 252, Cache Refresh API 254. The described APIs of the cache layer 250 are examples, and other APIs for the cache layer 250 are within the scopes of various embodiments. In some embodiments, the APIs of the cache layer 250 are configured to enable the user/vendor 150 to interact with the cache database 130 and/or to keep the cache database 130 consistent. In an example, the Cache Register API 252 is configured to enable cache registering. The cache registering comprises directly registering at least one of a policy or a configuration of at least one component of the CPE system 100 in the cache database 130. The cache registering further comprises updating a persistent database, e.g., the master database 120, of the CPE system 100 with the at least one policy or configuration directly registered in the cache database 130. In a further example, the Cache Refresh API 254 is configured to enable cache refreshing. The cache refreshing comprises rewriting the cache database 130 with business layer data and/or technical layer data from the persistent database, e.g., the master database 120, of the CPE system 100. The cache refreshing further comprises causing the components of the CPE system 100 to reload corresponding policies and/or business data from the cached business layer data 134 rewritten in the cache database 130, and/or to reload corresponding configurations from the cached technical layer data 136 rewritten in the cache database 130. Examples of cache registering and cache refreshing are further described with respect to FIG. 3A. In some embodiments, the cache layer 250 is further configured to enable other operational activities, including, but not limited to, manual update, reconcile, invalidation of data into the cache database 130. The cache layer 250 exposes APIs to interact with the cache database 130, where these APIs provide interfaces to keep the cache database 130 consistent, to support manual update, reconcile, and invalidate data into the cache database 130.

In some embodiments, the APIs of the API layers 210-250 are configured to enable interactions with the components of the CPE system 100 in runtime and in response to user input from the user/vendor 150.

FIG. 3A is a flow diagram of a process 300A of operating an API server in a CPE system, in accordance with some embodiments. In one or more embodiments, the API server corresponds to the API server 140 of the CPE system 100. In one or more embodiments, one or more of the operations of the process 300A are performed by a hardware processor, for example, as described with respect to FIG. 4.

At operation 305, user input is received at the API server 140, for example, from the user/vendor 150. In some embodiments, the user input comprises an instruction to update at least one of business layer data or technical layer data in the CPE system 100. In at least one embodiment, the user input comprises at least one policy or configuration to be updated for at least one component in the CPE system 100. In one or more embodiments, the at least one component having the policy or configuration to be updated comprises at least one of event source 102, event gate 104, first event queue 106, event enricher 108, second event queue 110, event transformer 112, event sink 114, event writer 116, event dispatcher 118, master database 120, cache database 130, DB2Cache module 138, API server 140.

In response to the received user input, the API server 140 is configured to update at least one of cached business layer data or cached technical layer data in a cache database of the CPE system. In some embodiments, there are two approaches 310, 320 to update the cache database. In the first approach 310, a persistent database is first updated, and then the cache database is updated or refreshed. In the second approach 320, the cache database is first updated, and then the persistent database is updated.

The first approach 310 comprises operations 312, 314, 316. At operation 312, in response to the user input, at least one of business layer data or technical layer data in a persistent database of the CPE system is updated. For example, at least one of the business layer 124 or the technical layer 126 in the master database 120 of the CPE system 100 is updated based on the user-defined or user-input policy or configuration data received from the user/vendor 150 via the API server 140.

At operation 314, at least one of cached business layer data or cached technical layer data in a cache database is updated, based on at least one of the business layer data or the technical layer data updated in the persistent database. For example, one or more of the DB2Cache modules 138 operate to synchronize at least one of the cached business layer data 134 or the cached technical layer data 136 in the cache database 130 with the corresponding updated business layer 124 or updated technical layer 126 in the master database 120. Alternatively, the DB2Cache modules 138 operate to clean the cached business layer data 134, cached technical layer data 136 or the entire cache database 130, and reload all business layer data and/or all technical layer data again from the refreshed master database 120.

At operation 316, at least one component of the CPE system is instructed to reload at least one of a corresponding policy or a corresponding configuration of the at least one component, from the at least one of the cached business layer data or the cached technical layer data updated in the cache database. For example, when the cache database 130 is updated, a component of the CPE system 100 to which the user-input policy or configuration is applicable is instructed by the API server 140 to reload the corresponding policy or configuration from the updated cached business layer data 134 or cached technical layer data 136. In another example, when the cache database 130 is refreshed, multiple components of the CPE system 100 are instructed by the API server 140 to reload their corresponding policies and/or configurations from the refreshed cached business layer data 134 and/or cached technical layer data 136.

The second approach 320 comprises operations 322, 324, 326. At operation 322, in response to the user input, at least one of cached business layer data or cached technical layer data in the cache database is directly updated. For example, at least one of the cached business layer data 134 or cached technical layer data 136 in the cache database 130 is directly updated, without using DB2Cache modules 138 and/or without accessing the master database 120, with the user-defined or user-input policy or configuration data received from the user/vendor 150 via the API server 140.

At operation 324, at least one component of the CPE system is instructed to reload at least one of a corresponding policy or a corresponding configuration of the at least one component, from the at least one of the cached business layer data or the cached technical layer data updated in the cache database. For example, when the cache database 130 is updated, a component of the CPE system 100 to which the user-input policy or configuration is applicable is instructed by the API server 140 to reload the corresponding policy or configuration from the updated cached business layer data 134 or cached technical layer data 136.

At operation 326, at least one of business layer data or technical layer data in the persistent database of the CPE system is updated. For example, at least one of the business layer 124 or the technical layer 126 in the master database 120 of the CPE system 100 is updated based on the user-defined or user-input policy or configuration data received from the user/vendor 150 via the API server 140. In some embodiments, the updating of the master database 120 and the cache database 130 with the user-defined or user-input policy or configuration data are performed concurrently. Alternatively, the at least one of the business layer 124 or the technical layer 126 in the master database 120 of the CPE system 100 is updated based on the updated cached business layer data 134 or cached technical layer data 136 in the cache database 130. In one or more embodiments, the updating of the master database 120 and operation 324 are performed concurrently.

In some embodiments, compared to the first approach 310, the second approach 320 shortens the time for deploying the new/updated policy and/or configuration at the corresponding CPE component.

FIG. 3B is a flow diagram of a process 300B of operating an API server in a CPE system, in accordance with some embodiments. In one or more embodiments, the API server corresponds to the API server 140 of the CPE system 100. In one or more embodiments, one or more of the operations of the process 300A are performed by a hardware processor, for example, as described with respect to FIG. 4.

At operation 345, user input is received at the API server 140, for example, from the user/vendor 150. In some embodiments, the user input is received at or via one or more APIs in one or more API layers of the API server 140.

At operation 350, in response to the user input and depending on which API or which API layer of the API server 140 the user input is received at/via, the API server 140 operates to perform one or more corresponding actions.

For example, when the user input is received at an operational API of the operational layer 210 to start, stop, refresh, or suspend one or more CPE components 270, the API server 140 is configured to execute a corresponding start, stop, refresh, suspend operation with respect to the one or more CPE components 270, as described with respect to one or more of FIGS. 1-2.

When the user input is received at a policy API or a configuration API of the corresponding policy layer 220 or configuration layer 230 with respect to one or more CPE components 270, the API server 140 is configured to register or update a corresponding policy or configuration of the one or more CPE components 270, as described with respect to one or more of FIGS. 1, 2 and 3A.

When the user input is received at a monitoring API of the monitoring layer 240, the API server 140 is configured to execute a corresponding monitoring, log searching, or health checking operation, as described with respect to one or more of FIGS. 1-2.

When the user input is received at a cache API of the cache layer 250 to register or refresh the cache database 130, the API server 140 is configured to execute a corresponding cache registering or cache refreshing for the cache database 130, as described with respect to one or more of FIGS. 1-2. In at least one embodiment, one or more advantages described herein are achievable by the CPE system 100, API server 140, and/or processes 300A, 300B.

The described methods and algorithms include example operations, but they are not necessarily required to be performed in the order shown. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

FIG. 4 is a schematic block diagram of a computer system 400, in accordance with some embodiments. In one or more embodiments, the computer system 400 is an example configuration of one or more CPE components as described herein, including, but not limited to, an API server, a database such as a master database and/or a cache database, an event source, an event gate, an event queue, an event enricher, an event transformer, an event sink, an event writer, an event dispatcher, or the like.

The computer system 400 includes a hardware processor 402 and a non-transitory, computer-readable storage medium 404. Storage medium 404, amongst other things, is encoded with, i.e., stores, computer program code 406, i.e., a set of executable instructions, such as one or more algorithms, programs, applications, sets of executable instructions for a correlation engine and policy manager, or the like, as described with respect to one or more of FIGS. 1-3B. Execution of instructions 406 by hardware processor 402 implements a portion or all of the methods described herein in accordance with one or more embodiments (hereinafter, the noted processes and/or methods).

Processor 402 is coupled to computer-readable storage medium 404 via a bus 408. Processor 402 is also coupled to an I/O interface 410 by bus 408. A network interface 412 is connected to processor 402 via bus 408. Network interface 412 is connected to a network 414, so that processor 402 and computer-readable storage medium 404 are connectable to external elements or devices via network 414. Processor 402 is configured to execute computer program code 406 encoded in computer-readable storage medium 404 in order to cause computer system 400 to be usable for performing a portion or all of the noted processes and/or methods. In one or more embodiments, processor 402 comprises a central processing unit (CPU), a multi-processor, a distributed processing system, an application specific integrated circuit (ASIC), and/or a suitable hardware processing unit.

In one or more embodiments, computer-readable storage medium 404 comprises an electronic, magnetic, optical, electromagnetic, infrared, and/or a semiconductor system (or apparatus or device). For example, computer-readable storage medium 404 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 404 includes a compact disk-read only memory (CD-ROM), a compact disk-read/write (CD-R/W), and/or a digital video disc (DVD).

In one or more embodiments, storage medium 404 stores computer program code 406 configured to cause computer system 400 to be usable for performing a portion or all of the noted processes and/or methods. In one or more embodiments, storage medium 404 also stores information or data 407, such as event data, consumer data, business data, policies, component configurations or the like, used in a portion or all of the noted processes and/or methods.

I/O interface 410 is coupled to external circuitry. In one or more embodiments, I/O interface 410 includes a keyboard, keypad, mouse, trackball, trackpad, touchscreen, and/or cursor direction keys for communicating information and commands to processor 402. Computer system 400 is configured to receive information through I/O interface 410. The information received through I/O interface 410 includes one or more of instructions, data, policies, configurations and/or other parameters for processing by processor 402. The information is transferred to processor 402 via bus 408. Computer system 400 is configured to receive information related to a user interface through I/O interface 410. The information is stored in computer-readable storage medium 404 as user interface (UI) 442.

Network interface 412 allows computer system 400 to communicate with network 414, to which one or more other computer systems are connected. Network interface 412 includes wireless network interfaces such as BLUETOOTH, WIFI, WIMAX, GPRS, LTE, 5G, 6G, WCDMA, or the like; or wired network interfaces such as ETHERNET, USB, IEEE-864 or the like. In one or more embodiments, a portion or all of noted processes and/or methods, is implemented in two or more computer system 400.

In some embodiments, a portion or all of the noted processes and/or methods is implemented as a standalone software application for execution by one or more hardware processors. In some embodiments, a portion or all of the noted processes and/or methods is implemented as a software application that is a part of an additional software application. In some embodiments, a portion or all of the noted processes and/or methods is implemented as a plug-in to a software application.

In some embodiments, a portion or all of the noted processes and/or methods is realized as functions of a program stored in a non-transitory computer readable recording medium. The non-transitory computer readable recording medium having the program stored therein is a computer program product. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, or the like.

In some embodiments, an application programming interface (API) server for a correlation engine and policy manager (CPE) system comprises a processor, and a memory coupled to the processor. The CPE system comprises a plurality of components of various component types, and each component among the plurality of components is configured to perform at least one corresponding processing on event data input to the CPE system. The memory is configured to store executable instructions that, when executed by the processor, cause the processor to perform at least one of registering, removing or updating a configuration of at least one component among the plurality of components of the CPE system, or changing a number of components of a same component type among the various component types, to scale up or down the CPE system.

In some embodiments, a method is performed at least in part by a processor of an application programming interface (API) server in a correlation engine and policy manager (CPE) system. The CPE system comprises a plurality of components, and each component among the plurality of components is configured to perform at least one corresponding processing on event data input to the CPE system. The method comprises, in response to user input, updating at least one of cached business layer data or cached technical layer data in a cache database of the CPE system. The cached business layer data include a plurality of policies to be applied to the event data by the plurality of components of the CPE system. The cached technical layer data include a plurality of configurations of the plurality of components of the CPE system. The method further comprises instructing at least one component among the plurality of components to reload at least one of a corresponding policy or a corresponding configuration of the at least one component, from at least one of the cached business layer data or the cached technical layer data updated in the cache database.

In some embodiments, a computer program product comprises a non-transitory, tangible computer readable storage medium storing a computer program that, when executed by a processor, causes the processor to provide at least one operational application programming interface (API), at least one policy API, at least one configuration API, at least one monitoring API, and at least one cache API. The at least one operational API is configured to enable starting, stopping, suspending and refreshing any component among a plurality of components of various component types in a correlation engine and policy manager (CPE) system. Each component among the plurality of components is configured to perform at least one corresponding processing on event data input to the CPE system. The at least one policy API is configured to enable registering and updating a policy to be applied to the event data by any component among the plurality of components of the CPE system when the component performs the at least one corresponding processing. The at least one configuration API is configured to enable registering and updating a configuration of any component among the plurality of components of the CPE system. The at least one monitoring API is configured to enable monitoring, log parsing, or health check for any component among the plurality of components of the CPE system. The at least one cache API is configured to enable cache registering and cache refreshing at a cache database of the CPE system. The cache database stores cached business layer data including a plurality of policies to be applied to the event data by the plurality of components of the CPE system, and cached technical layer data including a plurality of configurations of the plurality of components of the CPE system.

The foregoing outlines features of several embodiments so that those skilled in the art better understand the aspects of the present disclosure. Those skilled in the art should appreciate that they readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they make various changes, substitutions, and alterations herein without departing from the spirit and scope of the present disclosure.

What is claimed is:

1. An application programming interface (API) server for a correlation engine and policy manager (CPE) system, wherein the CPE system comprises a plurality of components of various component types, and each component among the plurality of components is configured to perform at least one corresponding processing on event data input to the CPE system, the API server comprising:
a processor; and
a memory coupled to the processor, wherein the memory is configured to store executable instructions that, when executed by the processor, cause the processor to perform at least one of:
registering, removing or updating a configuration of at least one component among the plurality of components of the CPE system, or
changing a number of components of a same component type among the various component types, to scale up or down the CPE system.

2. The API server of claim 1, wherein
the instructions, when executed by the processor, cause the processor to perform, in runtime and in response to user input, at least one of:
registering, removing or updating the configuration of any component among the plurality of components of the CPE system, or
changing the number of components of any component type among the various component types.

3. The API server of claim 1, wherein
the instructions, when executed by the processor, cause the processor to perform multicasting at least one of:
(i) the registered, removed or updated configuration of the at least one component, or
(ii) the changed number of components of the same component type, to one or more other components among the plurality of components.

4. The API server of claim 1, wherein
the instructions, when executed by the processor, cause the processor to perform
registering, removing or updating a policy to be applied by at least one component among the plurality of components of the CPE system to the event data when the at least one component performs the at least one corresponding processing.

5. The API server of claim 4, wherein
the policy comprises at least one of:
one or more actions to be taken by the at least one component, to which the policy is applicable, with respect to the event data,
one or more conditions to be fulfilled before the one or more actions are taken by the at least one component, or
one or more types of event data against which the one or more conditions are to be validated.

6. The API server of claim 1, wherein
the instructions, when executed by the processor, cause the processor to perform, in runtime and in response to user input,
registering, removing or updating a policy to be applied by any component among the plurality of components of the CPE system to the event data when the component performs the at least one corresponding processing.

7. The API server of claim 1, wherein
the instructions, when executed by the processor, cause the processor to perform
at least one of starting, stopping, suspending or refreshing at least one component among the plurality of components of the CPE system.

8. The API server of claim 1, wherein
the instructions, when executed by the processor, cause the processor to perform
at least one of monitoring, log parsing, or health check for at least one component among the plurality of components of the CPE system.

9. The API server of claim 1, wherein
the instructions, when executed by the processor, cause the processor to perform
at least one of cache registering or cache refreshing at a cache database of the CPE system,
the cache registering comprises directly registering at least one of a policy or a configuration of at least one component among the plurality of components in the cache database, and
the cache refreshing comprises rewriting the cache database with business layer data and technical layer data from a persistent database of the CPE system.

10. The API server of claim 9, wherein
the cache registering further comprises updating the persistent database of the CPE system with the at least one policy or configuration directly registered in the cache database, and
the cache refreshing further comprises causing the plurality of components to reload
corresponding policies from the business layer data rewritten in the cache database, and
corresponding configurations from the technical layer data rewritten in the cache database.

11. A method performed at least in part by a processor of an application programming interface (API) server in a correlation engine and policy manager (CPE) system, wherein the CPE system comprises a plurality of components, and each component among the plurality of components is configured to perform at least one corresponding processing on event data input to the CPE system, the method comprising:
in response to user input, updating at least one of cached business layer data or cached technical layer data in a cache database of the CPE system, wherein
the cached business layer data include a plurality of policies to be applied to the event data by the plurality of components of the CPE system, and
the cached technical layer data include a plurality of configurations of the plurality of components of the CPE system; and
instructing at least one component among the plurality of components to reload at least one of a corresponding policy or a corresponding configuration of the at least one component, from at least one of the cached business layer data or the cached technical layer data updated in the cache database.

12. The method of claim 11, further comprising:
in response to the user input, updating at least one of business layer data or technical layer data in a persistent database of the CPE system; and
updating at least one of the cached business layer data or the cached technical layer data in the cache database, based on at least one of the business layer data or the technical layer data updated in the persistent database.

13. The method of claim 12, wherein
the updating the persistent database comprises at least one of registering, removing or updating at least one of the corresponding policy of the at least one component in the business layer data or the corresponding configuration of the at least one component in the technical layer data, in response to the user input.

14. The method of claim 11, further comprising:
in response to the user input, directly updating at least one of the cached business layer data or the cached technical layer data in the cache database; and
updating at least one of business layer data or technical layer data in a persistent database of the CPE system, based on
the user input, or
at least one of the cached business layer data or the cached technical layer data updated in the cache database.

15. The method of claim 14, wherein
the directly updating the cache database comprises at least one of directly registering, removing or updating at least one of the corresponding policy of the at least one component in the cached business layer data or the corresponding configuration of the at least one component in the cached technical layer data, in response to the user input.

16. A computer program product comprising a non-transitory, tangible computer readable storage medium storing a computer program that, when executed by a processor, causes the processor to provide:
at least one operational application programming interface (API) configured to enable starting, stopping, suspending and refreshing any component among a plurality of components of various component types in a correlation engine and policy manager (CPE) system,
wherein each component among the plurality of components is configured to perform at least one corresponding processing on event data input to the CPE system,
at least one policy API configured to enable registering and updating a policy to be applied to the event data by any component among the plurality of components of the CPE system when the component performs the at least one corresponding processing,
at least one configuration API configured to enable registering and updating a configuration of any component among the plurality of components of the CPE system,
at least one monitoring API configured to enable monitoring, log parsing, or health check for any component among the plurality of components of the CPE system, and
at least one cache API configured to enable cache registering and cache refreshing at a cache database of the CPE system, wherein the cache database stores
cached business layer data including a plurality of policies to be applied to the event data by the plurality of components of the CPE system, and
cached technical layer data including a plurality of configurations of the plurality of components of the CPE system.

17. The computer program product of claim 16, wherein
one or more of the at least one operational API, the at least one policy API, the at least one configuration API, the at least one monitoring API, and the at least one cache API are configured to enable corresponding interactions with the plurality of components of the CPE system in runtime and in response to user input.

18. The computer program product of claim 16, wherein
the at least one configuration API is configured to enable changing a number of components of a same component type among the various component types, to scale up or down the CPE system.

19. The computer program product of claim 16, wherein
the at least one configuration API is configured to enable changing a flow of the event data through various components among the plurality of components.

20. The computer program product of claim 16, wherein
the plurality of components comprises one or more of an event source, an event gate, an event queue, an event enricher, an event transformer, an event sink, an event writer, and an event dispatcher.
